(19) United States
(12) Patent Application Publication
(10) Pub. No.: US 2009/0225207 A1
(43) Pub. Date: Sep. 10, 2009

(54) OPTICAL POINTING DEVICE AND METHOD OF ADJUSTING EXPOSURE TIME AND COMPARISON VOLTAGE RANGE OF THE OPTICAL POINTING DEVICE

(75) Inventors: DUCK-YOUNG JUNG, Yongin-si, (KR); JONG-TAEK KWAK, Yongin-si, (KR); WOO-SEOK LEE, Yongin-si, (KR); HAE-KYUNG YUM, Yongin-si, (KR)

Correspondence Address: CANTOR COLBURN, LLP, 20 Church Street, 22nd Floor, Hartford, CT, 06103, US

(73) Assignee: ATLAB INC., Yongin-si (KR)

(21) Appl. No.: 12/468,418

(22) Filed: May 19, 2009

Related U.S. Application Data
(63) Continuation-in-part of application No. 10/744,887, filed on Dec. 23, 2003, now abandoned.

(30) Foreign Application Priority Data
Dec. 23, 2002 (KR) 1020020082889

(51) Int. Cl. H04N 5/335

(52) U.S. Cl. 348/296; 348/E05.091

(57) ABSTRACT

An optical pointing device and a method of adjusting an exposure time and a comparison voltage range of the optical pointing device are provided. The optical pointing device obtains a high-resolution image using a low-resolution analog-to-digital (A/D) converter, and calculates a movement value using the obtained image. Thus, the optical pointing device can calculate an accurate movement value, reduce production cost, and provide a rapid operating speed and low power consumption. Further, the optical pointing device can use the A/D converter having a relatively low signal-to-noise ratio of an input signal.

### CROSS-REFERENCE TO RELATED APPLICATION

This application is a continuation-in-part application of U.S. application Ser. No. 10/744,887 filed Dec. 23, 2003, which claims the benefit of Korean Patent Application No. 2002-82889, filed on Dec. 23, 2002, the disclosures of which are hereby incorporated herein by reference in their entirety.

### BACKGROUND OF THE INVENTION

1. Field of the Invention

The present invention relates to an optical pointing device and a method of adjusting an exposure time and a comparison voltage range of the optical pointing device and, more particularly, to an optical pointing device capable of obtaining a high-resolution image using a low-resolution analog-to-digital (A/D) converter to calculate an accurate movement value, and a method of adjusting an exposure time and a comparison voltage range of the optical pointing device.

2. Description of the Related Art

FIG. 1 shows an internal block diagram of a conventional optical pointing device.

Referring to FIG. 1, the conventional optical pointing device includes a light source 100, an image sensor 110, an analog-to-digital (A/D) converter 120, an image data processor 130 and a shutter control circuit 140.

The light source 100 emits light toward a subject (e.g. the surface of a worktable), and the image sensor 110 outputs analog signals IMO of pixels according to a quantity of the light reflected from the subject. The image sensor 110 is provided with a plurality of pixels, each of which responds to a shutter control signal CSHT to charge voltage in proportion to a quantity of light input when a shutter is turned on. Then, when the shutter is turned off, the image sensor 110 outputs the analog signals IMO of the pixels, each of which has a charge voltage.

The A/D converter 120 receives the analog signals IMO of the image sensor 110, and converts the received analog signals IMO into N-bit digital signals ADCO.

The image data processor 130 receives the N-bit (N is natural number) digital signals ADCO of the pixels which are output from the A/D converter 120, calculates a movement value MV using the received N-bit digital signals ADCO, and outputs the calculated movement value MV.

Here, the movement value MV can be obtained using correlation between the previously received N-bit digital signals ADCO and currently received N-bit digital signals ADCO.

Further, the image data processor 130 determines an exposure time of the image sensor 110 which allows the quantity of light input into the image sensor 110 to be maintained within a predetermined range using the received N-bit digital signals ADCO, generates a first shutter control signal CSHT1 having an m-bit (m is natural number) code value corresponding to the determined exposure time, and provides the generated the first shutter control signal CSHT1 to the shutter control circuit 140.

The shutter control circuit 140 receives the first shutter control signal CSHT1 which is provided from the image data processor 130, generates a second shutter control signal CSHT2 having a pulse width corresponding to the first shutter control signal CSHT1, and provides the generated the second shutter control signal CSHT2 to an electronic shutter (not shown) composed of a complementary metal oxide semiconductor (CMOS) transistor in the image sensor 110. In other words, the second shutter control signal CSHT2 is an exposure time TS of the image sensor 110 corresponding to a shutter-on time section during which the electronic shutter is turned on in response to an activated pulse width section.

In the above-mentioned configuration, the image data processor 130 has been described as functionally separate from the shutter control circuit 140. However, the image data processor 130 may include the function of the shutter control circuit 140 according to necessity.

FIG. 2 is a graph explaining how the image data processor of FIG. 1 determines an exposure time of the image sensor.

In FIG. 2, plotted lines represents charge voltages PS1 to PS3 according to an exposure time of each unit pixel of the image sensor 110, an X axis represents an exposure time of the image sensor 110, and a Y axis represents a code corresponding to a charge voltage.

Here, it is assumed that the optical pointing device includes the 4-bit A/D converter 120 having a code value range between “0” and “15” and a central code value of “7,” and the image sensor 110 having three pixels.

Under this assumption, referring to FIG. 2 again, the image data processor 130 selects an exposure time TS such that an average value of three charge voltages PS1 to PS3 output from the image sensor 110 is distributed on “7,” which is the central code value of the A/D converter 120.

In detail, the image data processor 130 selects an exposure time TS such that an average voltage between the charge voltage PS1 having the minimum voltage value and the charge voltage PS3 having the maximum voltage value on the basis of the same time is distributed on the central code value of the A/D converter 120, “7”.

Further, the image data processor 130 generates the first shutter control signal CSHT1 having a code value corresponding to the selected exposure time TS.

Although the image sensor 110 may have pixels ranging from one to several millions, all of the pixels are controlled by shutter control signals CSHT2 having the same value.

Thus, when too much or too little light is incident on the image sensor 110, the average value of the analog signals IMO provided from the image sensor 110 excessively converge on the upper limit codes CODE10 to CODE15 or the lower limit codes CODE0 to CODE5 of the A/D converter 120.

In this case, the A/D converter 120 fails to normally recognize these signals, thus failing to perform normal A/D conversion. In other words, the A/D converter 120 does not generate digital signals required by the optical pointing device to calculate a movement value.

Thus, as in FIG. 2, the conventional optical pointing device is equipped with the image data processor 130 controlling the exposure time of the image sensor 110, thereby allowing the analog signals IMO generated through the image sensor 110 to be always distributed on the central code of the A/D converter 120.

Here, the analog signals output by the image sensor 110 are analog image signals, while the digital signals output by the A/D converter 120 are digital image signals.

FIG. 3 shows one embodiment of a circuit diagram of the A/D converter of FIG. 1, in which the A/D converter 120 includes a comparison voltage generator 121 and an N-bit comparator 123.

The comparison voltage generator 121 receives fixed reference voltage values from first and second reference voltages Vref1 and Vref2, and determines a comparison voltage range. Here, the comparison voltage generator 121 divides the comparison voltage range into 2^{N} units, and generates and outputs 2^{N} comparison voltages. Further, differences between the comparison voltages generated from the comparison voltage generator 121 are uniformly maintained at all times.

The N-bit comparator 123 compares the 2^{N} comparison voltages transmitted from the comparison voltage generator 121 with the voltages of the analog signals IMO transmitted from the image sensor 110, and outputs the compared results in the form of an N-bit digital signal ADCO.

In this manner, the conventional A/D converter 120 converts the analog signals IMO into the N-bit digital signals ADCO using the 2^{N} comparison voltages, the differences between which are uniform at all times.

Thus, when the voltage differences of the analog signals of the pixels input into the A/D converter 120 are large enough to be distinguished by the 2^{N} comparison voltages, the A/D converter 120 recognizes the voltage differences of the analog signals IMO, and generates the N-bit digital signals ADCO corresponding to the respective voltages.

Accordingly, the conventional A/D converter 120 can provide an image that accurately reflects the shape of a subject to the image data processor.

By contrast, when the voltage differences of the analog signals IMO of the pixels input into the A/D converter 120 are too small to be distinguished by the 2^{N} comparison voltages, the A/D converter 120 fails to distinguish the voltage differences of the analog signals IMO, and the A/D converter 120 cannot provide an image that accurately reflects the shape of a subject to the image data processor.

Generally, the optical pointing device has to accurately recognize the image of the subject in order to calculate an accurate movement value. Thus, the optical pointing device is designed to calculate the accurate movement value using a high-resolution A/D converter capable of distinguishing even very small voltage differences of the analog signals IMO.

However, with the high-resolution A/D converter, there are problems in that a layout area of the A/D converter is increased, and in that manufacturing cost and consumption power of the optical pointing device are inevitably increased.

This is because, in view of characteristics of the circuit of the A/D converter, when the number of bits increases by 1, a chip size of the A/D converter increases doubly, and the consumption power of the A/D converter increases twice.

### SUMMARY OF THE INVENTION

The present invention is directed to provide an optical pointing device capable of obtaining a high-resolution image of a surface using a low-resolution analog-to-digital (A/D) converter, thereby calculating an accurate movement value.

The present invention is also directed to provide a method of adjusting an exposure time and a comparison voltage range of the optical pointing device.

According to an aspect of the present invention, there is provided an optical pointing device, which includes a light source emitting light, a first image sensor on which the light reflected from a subject is incident, receiving an image of the subject in the form of the light to generate first analog signals of pixels, a first analog-to-digital (A/D) converter varying a comparison voltage range according to a conversion control signal, and converting the first analog signals of the pixels into first digital signals of the pixels according to the varied comparison voltage range, and an image data processor calculating a movement value in response to the first digital signals of the pixels, and generating and outputting a first shutter control signal for controlling an exposure time of the first image sensor.

According to another aspect of the present invention, there is provided a method of adjusting an exposure time and a comparison voltage range of an optical pointing device, in which the optical pointing device includes a light source emitting light, a first image sensor on which the light reflected from a subject is incident, receiving an image of the subject in the form of the light to generate first analog signals of pixels, a first analog-to-digital (A/D) converter varying a comparison voltage range according to a conversion control signal, and converting the first analog signals of the pixels into first digital signals of the pixels according to the varied comparison voltage range, and an image data processor calculating a movement value in response to the first digital signals of the pixels, and generating and outputting a first shutter control signal for controlling an exposure time of the first image sensor, the method including: emitting light; receiving the light reflected from the subject, and receiving the image of the subject in the form of the light to generate first analog signals of the pixels; varying the comparison voltage range according to the conversion control signal, and converting the first analog signals of the pixels into the first digital signals of the pixels according to the varied comparison voltage range; calculating the movement value using the correlation between the first digital signals of the pixels stored during previous operation and the first digital signals of the pixels applied at present; and adjusting and outputting the conversion control signal and the first shutter control signal for controlling the exposure time of the first image sensor.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 shows a block circuit diagram of a conventional optical pointing device;

FIG. 2 is a graph explaining how the image data processor of FIG. 1 determines an exposure time of the image sensor;

FIG. 3 shows one embodiment of a circuit diagram of the A/D converter of FIG. 1;

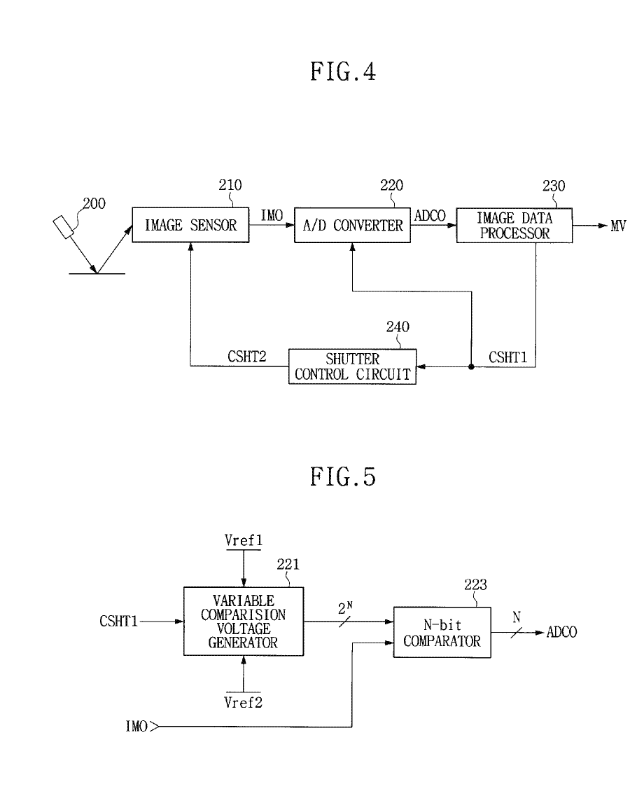

FIG. 4 is a block diagram showing an optical pointing device according to a first embodiment of the present invention;

FIG. 5 is an internal block diagram of the A/D converter of FIG. 4;

FIG. 6 is a graph explaining how the A/D converter of FIG. 5 generates N-bit digital signals;

FIG. 7 shows an example of the A/D converter of FIG. 5;

FIG. 8 shows another example of the A/D converter of FIG. 5;

FIG. 9 is a block diagram showing an optical pointing device according to a second embodiment of the present invention;

FIG. 10 is an internal block diagram of the A/D converter of FIG. 9;

FIG. 11 is a block diagram showing an optical pointing device according to a third embodiment of the present invention;

FIGS. 12 and 13 are flowcharts explaining how the image data processor of FIG. 11 adjusts the exposure time of the image sensor and the comparison voltage range;

FIG. 14 is a view explaining a method of rapidly determining the exposure time of an image sensor in an optical pointing device according to an exemplary embodiment of the present invention;

FIGS. 15 and 16 are flowcharts explaining how an optical pointing device adjusts the exposure time of an image sensor and a comparison voltage range using the method of FIG. 14;

FIGS. 17 and 18 are flowcharts explaining how the optical pointing device of FIG. 9 adjusts the exposure time of the image sensor and the comparison voltage range using the method of FIG. 13; and

FIGS. 19 and 20 show an operating difference between a conventional optical pointing device and a proposed optical pointing device.

### DETAILED DESCRIPTION OF THE INVENTION

An optical pointing device and a method of adjusting an exposure time and a comparison voltage range of the optical pointing device according to exemplary embodiments of the present invention will now be described in detail with reference to the accompanying drawings.

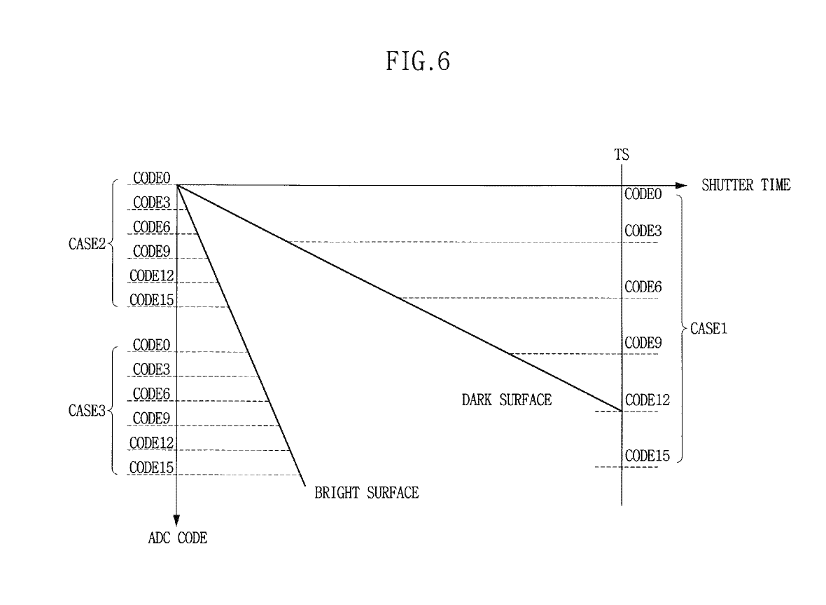

FIG. 4 is a block diagram showing an optical pointing device according to a first embodiment of the present invention.

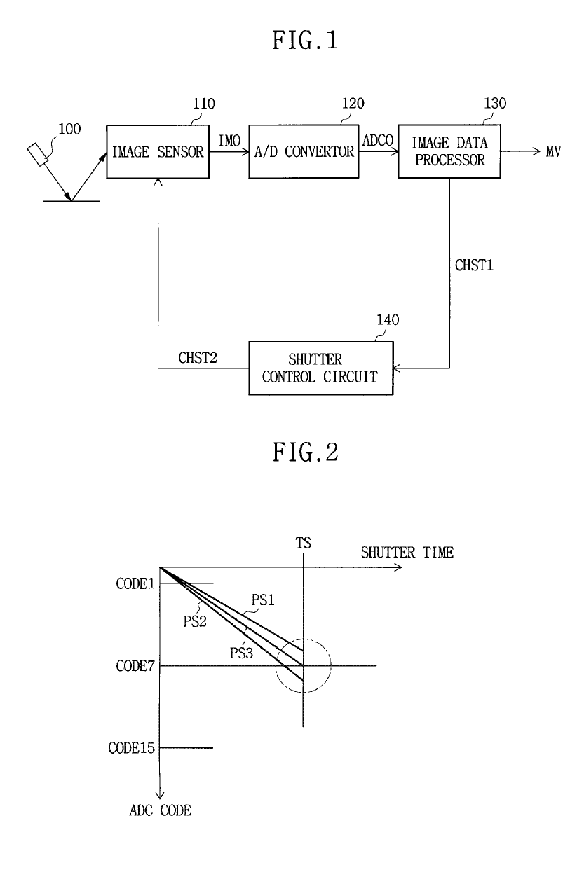

In the optical pointing device shown in FIG. 4 in accordance with a first embodiment of the present invention, a light source 200, an image sensor 210, an image data processor 230 and a shutter control circuit 240 are functionally identical to those of the optical pointing device shown in FIG. 1. However, unlike the A/D converter 120 of FIG. 1, an A/D converter 220 of FIG. 4 receives a first shutter control signal CSHT1, varies a comparison voltage range in response to the first shutter control signal CSHT1, and converts analog signals IMO received from the image sensor 210 into digital signals ADCO according to the varied comparison voltage range.

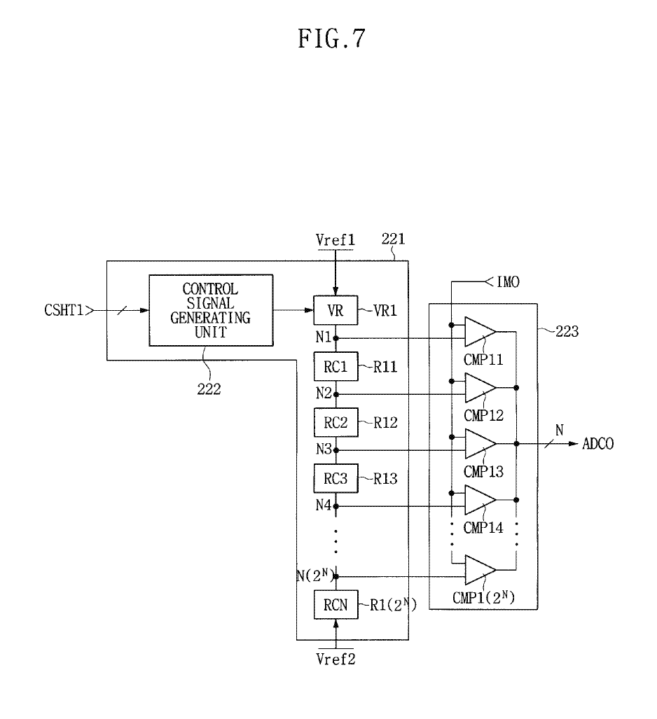

FIG. 5 is an internal block diagram of an A/D converter of FIG. 4.

As shown in the drawing, the A/D converter 220 includes a variable comparison voltage generator 221 and an N-bit comparator 223. The A/D converter 220 receives the first shutter control signal CSHT1 from the image data processor 230.

The variable comparison voltage generator 221 receives fixed reference voltage values from first and second reference voltages Vref1 and Vref2, and varies the comparison voltage range applied to the N-bit comparator 223 in response to the first shutter control signal CSHT1.

Then, the varied comparison voltage range is divided into 2^{N} units. The 2^{N} comparison voltages are generated and outputted.

Thus, voltage differences between the comparison voltages generated from the variable comparison voltage generator 221 are variously adjusted according to the first shutter control signal CSHT1.

Here, the variable comparison voltage generator 221 can be realized as a plurality of subdivided comparators or by analog continuous voltage control.

The N-bit comparator 223 receives the 2^{N} comparison voltages from the variable comparison voltage generator 221 and the analog signals IMO from the image sensor 210 to compare voltage magnitudes, and generates and outputs N-bit digital signals ADCO corresponding to the compared results. Here, the A/D converter 220 is assumed to a full flash type architecture, but it is natural to use other A/D converter architecture.

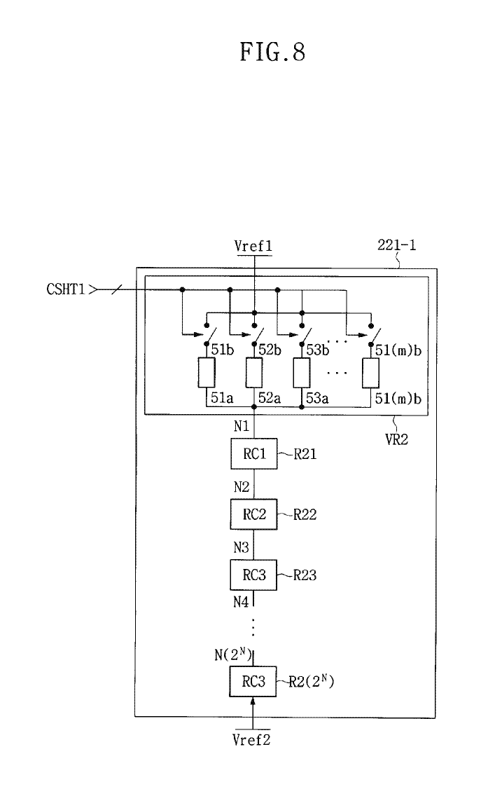

FIG. 6 is a graph explaining how the A/D converter of FIG. 5 generates N-bit digital signals.

As described above, the A/D converter of FIG. 5 varies the comparison voltage range in response to the first shutter control signal CSHT1, and converts the analog signals IMO received from the image sensor into the digital signals according to the varied comparison voltage range. Since the comparison voltage range is varied in response to the first shutter control signal CSHT1 received from the image data processor 230, although the same analog signals IMO are received from the image sensor 210, the N-bit digital signals ADCO having different code values are output according to the first shutter control signal CSHT1. For example, in FIG. 6, CASE1 represents a case in which the first shutter control signal CSHT1 has a medium value, and CASE2 and CASE3 represent cases in which the first shutter control signals CSHT1 have high and low values, respectively. More precisely, when the first shutter control signal CSHT1 has the high value due to a small quantity of incident light, an exposure time TS becomes long. Further, differences between the comparison voltages become narrow as in CASE2, and all of the N-bit comparison voltages are located on the area of a low voltage level so as to correspond to low luminance distribution. In contrast, when the first shutter control signal CSHT1 has the low value due to a large quantity of incident light, the exposure time TS becomes short. Further, the differences between the comparison voltages become narrow as in CASE3, but all of the N-bit comparison voltages are located on the area of a high voltage level so as to correspond to high luminance distribution. When the differences between the comparison voltages are medium, the differences between the comparison voltages are distributed widely as in CASE1.

In the above description, the exposure time TS is varied in proportion to the value of the first shutter control signal CSHT1, and the N-bit comparison voltages are varied so as to correspond to the high and low luminance distribution in inverse proportion to the value of the first shutter control signal CSHT1. However, the optical pointing device may be designed such that the exposure time TS is operated in inverse proportion to the value of the first shutter control signal CSHT1. Furthermore, the comparison voltages may also be varied so as to correspond to the luminance distribution in proportion to the value of the first shutter control signal CSHT1.

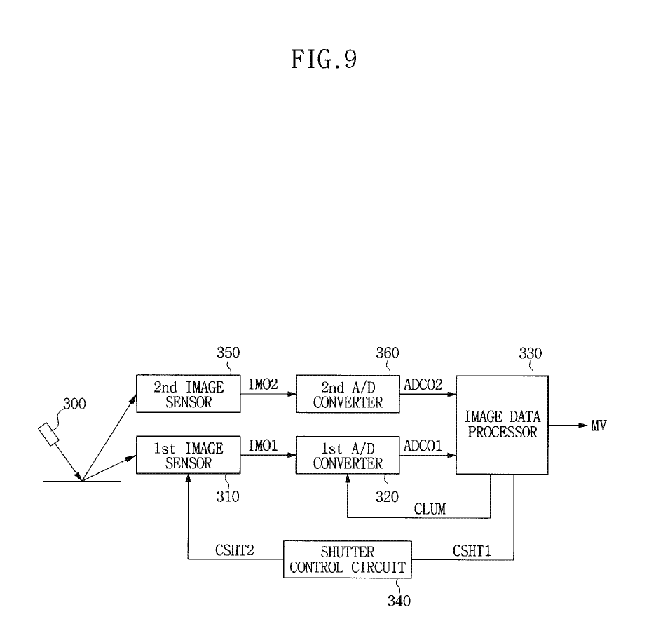

FIG. 7 shows an example of the A/D converter of FIG. 5.

Referring to FIG. 7, the variable comparison voltage generator 221 includes a variable resistance circuit VR1 connected with the first reference voltage Vref1 and varying a resistance value VR in response to a comparison voltage control signal, 2^{N} comparison voltage generating circuits R11 to R1(2^{N}) dependently connected in series between the variable resistance circuit VR1 and the second reference voltage Vref2, and a control signal generating unit 222 generating the comparison voltage control signal having an adjustable voltage value in response to the first shutter control signal CSHT1.

The N-bit comparator 223 includes 2^{N} comparators CMP11 to CMP1(2^{N}), which are connected with the variable comparison voltage generating circuits R11 to R1(2^{N}), respectively.

The first shutter control signal CSHT1 is a digital signal, a code value of which is varied according to an exposure time. Thus, the control signal generating unit 222 generates a voltage value of the comparison voltage control signal corresponding to the code value of the first shutter control signal CSHT1. The variable resistance circuit VR1 varies its resistance value VR according to the voltage value of the comparison voltage control signal.

Hereinafter, an operation of the A/D converter will be described with reference to FIG. 5.

Here, it is assumed that all of the 2^{N} comparison voltage generating circuits R11 to R1(2^{N}) of the A/D converter have the same resistance value R.

The control signal generating unit 222 adjusts the voltage value of the comparison voltage control signal according to the code value of the received first shutter control signal CSHT1, and the variable resistance circuit VR1 varies the resistance value VR in response to the comparison voltage control signal having the adjusted voltage value.

The variable resistance circuit VR1 having the varied resistance value VR outputs a comparison voltage having a value of “Vref1−(Vref1−Vref2)×VR/(VR+2^{N}×R)” to a first output node N1.

Then, the first comparison voltage generating circuit R11 outputs the comparison voltage having a value of “Vref1−(Vref1−Vref2)×(VR+R)/(VR+2^{N}×R)” to a second output node N2, and the second comparison voltage generating circuit R12 outputs a comparison voltage having a value of “Vref1−(Vref1−Vref2)×(VR+2R)/(VR+2^{N}×R)” to a third output node N3.

In this manner, the third to 2^{N}-th comparison voltage generating circuits R13 to R1(2^{N}) output the respective comparison voltages to fourth to 2^{N}-th output nodes N4 to N(2^{N}).

The 2^{N} comparators CMP11 to CMP1(2^{N}) receiving the respective comparison voltages compare magnitudes of the comparison voltages with those of the voltages of the analog signals IMO output from the image sensor 210, and output the compared results.

The N-bit comparator 233 generates and outputs N-bit digital signals ADCO corresponding to values of the 2^{N} compared results of the 2^{N} comparators CMP11 to CMP1(2^{N}). The N-bit comparator 233 may comprise a decoder (not shown) to generate N-bit digital signals ADCO from the values of the 2^{N} compared results.

In this manner, the A/D converter of FIG. 7 outputs the N-bit digital signals as in the conventional A/D converter, and continuously varies the comparison voltage range according to the first shutter control signal CSHT1 to thus increase its resolution.

In the above-mentioned configuration, the variable resistance circuit VR1 is disposed between the first reference voltage Vref1 and the first comparison voltage generating circuit R11, and the voltage differences between the comparison voltages provided by the A/D converter are varied. However, if necessary, the variable resistance circuit VR1 may be disposed between the second reference voltage Vref2 and the 2^{N}-th comparison voltage generating circuit R1(2^{N}), and the voltage differences between the comparison voltages provided by the A/D converter may also be varied.

Similarly, a first variable resistance circuit may be disposed between the first reference voltage Vref1 and the first comparison voltage generating circuit R11, and a second variable resistance circuit may be disposed between the second reference voltage Vref2 and the 2^{N}-th comparison voltage generating circuit R1(2^{N}). The voltage differences between the comparison voltages provided by the A/D converter may be varied through these variable resistance circuits.

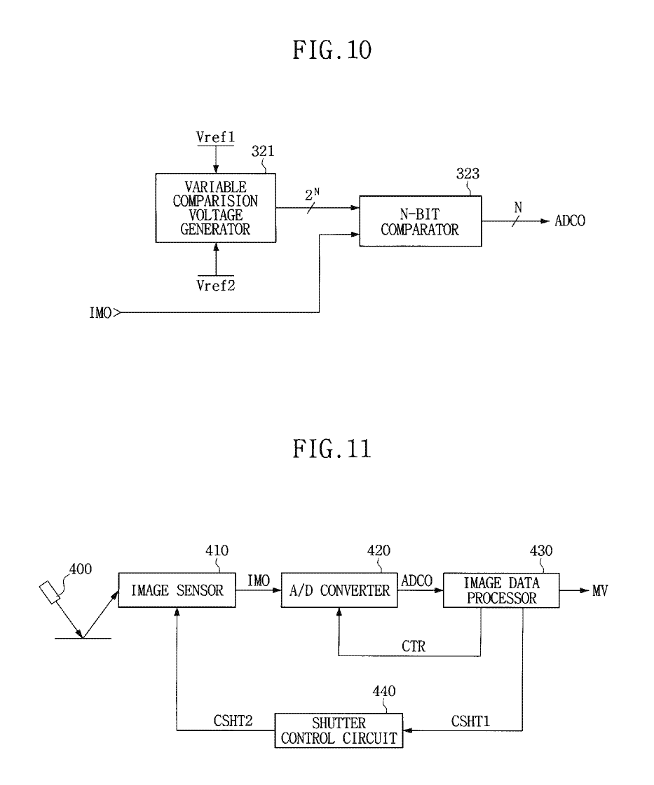

FIG. 8 shows another example of the A/D converter of FIG. 5. In FIG. 8, only a variable comparison voltage generator 221-1 is shown as a part of the A/D converter. An N-bit comparator is not separately shown because it has the same configuration as the N-bit comparator 223 shown in FIG. 7.

The A/D converter of FIG. 8 includes m resistance circuits 51a to 5(m)a and m switches 51b to 5(m)b instead of the variable resistance circuit VR1 of the variable comparison voltage generator 221 of FIG. 5.

A detailed description will be omitted regarding the A/D converter of FIG. 8 which has the same configuration and operation as that of FIG. 5.

The m resistance circuits 51a to 5(m)a are connected to the first reference voltage Vref1 in parallel, and the m switches 51b to 5(m)b are disposed between the respective m resistance circuits 51a to 5(m)a and the reference voltage Vref1.

The m switches 51b to 5(m)b control connection between the m resistance circuits 51a to 5(m)a and the 2^{N} comparison voltage generating circuits R21 to R2(2^{N}) in response to the m-bit code value of the first shutter control signal CSHT1.

If the bit number of the first shutter control signal CSHT1 is more than m, the m switches 51b to 5(m)b may be controlled using m bits of the first shutter control signal CSHT1.

Thus, a variable comparison voltage generator 221-1 controls connection between a specified at least one of the resistance circuits and the 2^{N} comparison voltage generating circuits R21 and R2(2^{N}) according to the exposure time of the first shutter control signal CSHT1, varies a comparison voltage range of the A/D converter, divides the varied comparison voltage range into 2^{N} units, and generates and outputs 2^{N} comparison voltages, which become references of the N codes provided by the A/D converter, respectively.

In this manner, the A/D converter of FIG. 8 sets multiple comparison voltage ranges, and selects a specified one of the comparison voltage ranges according to the first shutter control signal CSHT1, so that the A/D converter increases its resolution.

In the above-mentioned configuration, the m resistance circuits 51a to 5(m)a and the m switches 51b to 5(m)b are disposed between the first reference voltage Vref1 and the first comparison voltage generating circuit R21, and the voltage differences between the comparison voltages provided by the A/D converter are varied. However, if necessary, the m resistance circuits 51a to 5(m)a and the m switches 51b to 5(m)b may be disposed between the second reference voltage Vref2 and the 2^{N}-th comparison voltage generating circuit R2(2^{N}), and the voltage differences between the comparison voltages provided by the A/D converter may be varied.

Similarly, first resistance circuits and switches may be disposed between the first reference voltage Vref1 and the first comparison voltage generating circuit R11, and second resistance circuits and switches may be disposed between the second reference voltage Vref2 and the 2^{N}-th comparison voltage generating circuit R2(2^{N}), and the voltage differences between the comparison voltages provided by the A/D converter may be varied.

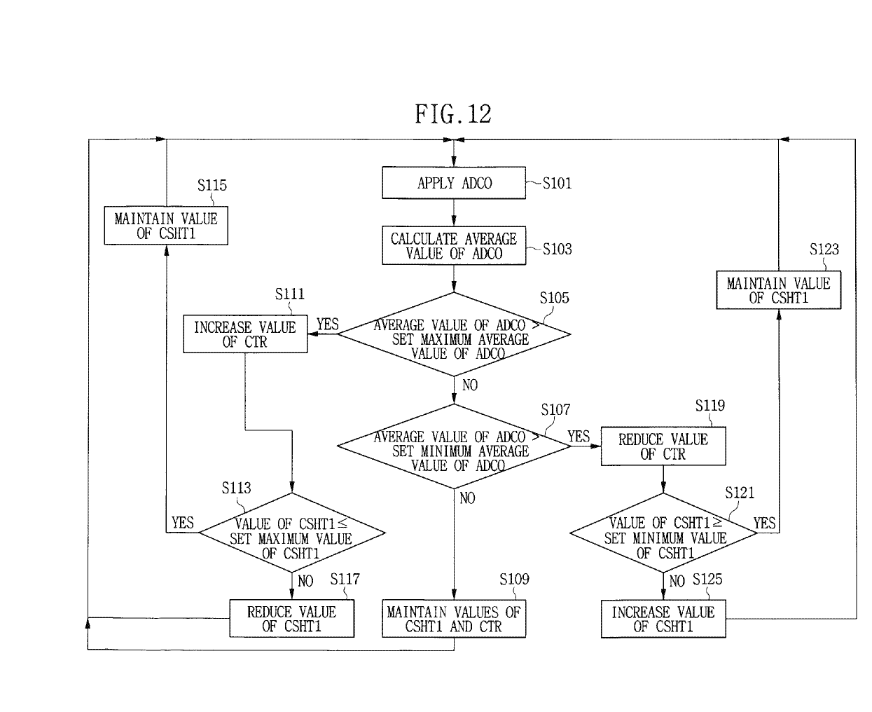

FIG. 9 is a block diagram showing an optical pointing device according to a second embodiment of the present invention.

Unlike the optical point device of FIG. 4, the optical point device of FIG. 9 further includes a second image sensor 350 for detecting luminance, and a second A/D converter 360. A first image sensor 310 is identical to the image sensor 210 of FIG. 4.

The second image sensor 350 is for detecting only the luminance, and thus has pixels smaller than those of the first image sensor 310. Generally, the optical pointing device compares a previously obtained image with a currently obtained image in order to calculate a movement value. To this end, each image requires a predetermined level of resolution, so that the first image sensor 310 requires a large number of pixels (e.g. one hundred thousand pixels). In contrast, the second image sensor 350 can sufficiently detect the luminance even with a very small number of pixels (e.g. ten pixels or fewer).

The second A/D converter 360 receives second analog signals IMO2 from the second image sensor 350, and converts the second analog signals IMO2 into second digital signals ADCO2. Since the second image sensor 350 is for detecting the luminance, the second A/D converter 360 compares a fixed comparison voltage with the second analog signals IMO2, thereby generating the second digital signals ADCO2, like the A/D converter 120 of FIG. 1. The second digital signals ADCO2 generated from the second A/D converter 360 may have the same number of N bits or a different number of bits, compared to a first A/D converter 320.

Meanwhile, like the image data processor 230 of FIG. 4, an image data processor 330 of FIG. 9 outputs a first shutter control signal CSHT1 in response to first digital signals ADCO1 output by the first A/D converter 320 as well as an luminance control signal CLUM for controlling a comparison voltage range of the first A/D converter 320 in response to the second digital signals ADCO2 received from the second A/D converter 360 aside from the first shutter control signal CSHT1.

Unlike the A/D converter 220 of FIG. 4, the first A/D converter 320 varies a comparison voltage range in response to the luminance control signal CLUM, and converts the first analog signals IMO1 received from the first image sensor 310 into the first digital signals ADCO1 according to the varied comparison voltage range.

Since the first A/D converter 320 varies the comparison voltage range in response to the luminance control signal CLUM generated in response to the second digital signals ADCO2, the first A/D converter 320 can more accurately adjust the comparison voltage range to actual luminance, compared to the A/D converter 220 of FIG. 4 which varies the comparison voltage range in response to the first shutter control signal CSHT1 which the image data processor 230 generates in response to the previously adjusted digital signals ADCO.

In the above-mentioned configuration, the image data processor 330 generates the first shutter control signal CSHT1 in response to the first digital signals ADCO1. However, the image data processor 330 may generate the first shutter control signal CSHT1 in response to the second digital signals ADCO2. Since the second image sensor 350 has a very small number of pixels compared to the first image sensor 310, the image data processor 330 can reduce an amount of data to be calculated in order to generate the first shutter control signal CSHT1 when generating the first shutter control signal CSHT1 in response to the second digital signals ADCO2. Accordingly, the image data processor 330 can rapidly generate the first shutter control signal CSHT1.

Further, since the first A/D converter 320 varies the comparison voltage range in response to the luminance control signal CLUM, the image data processor 330 can directly generate a second shutter control signal CSHT2 having a predetermined pulse width in response to the first digital signals ADCO1. In this manner, when the image data processor 330 is configured to generate the second shutter control signal CSHT2, a shutter control circuit 340 can be omitted.

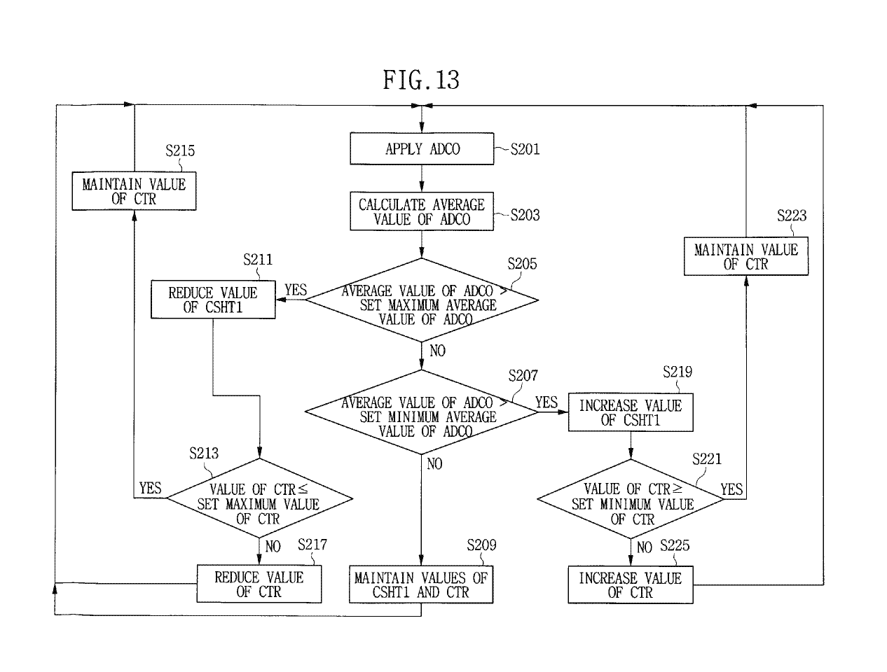

FIG. 10 is an internal block diagram of the A/D converter of FIG. 9.

Referring to FIG. 10, like the A/D converter 220 of FIG. 5, the A/D converter 320 includes a variable comparison voltage generator 321 and an N-bit comparator 323. The N-bit comparator 323 is identical to the N-bit comparator 223 of FIG. 5. However, the variable comparison voltage generator 321 varies the comparison voltage range provided to the N-bit comparator 323 in response to the luminance control signal CLUM, unlike the variable comparison voltage generator 221 of FIG. 5 which receives the first shutter control signal CSHT1 to vary the reference voltage. The variable comparison voltage generator 321 divides the varied comparison voltage range into N units, and generates and outputs N comparison voltages. Thus, voltage differences between the comparison voltages generated from the variable comparison voltage generator 321 are variously adjusted according to the luminance control signal CLUM.

The AD converter 320 of FIG. 10 has the same configuration as the AD converter 220 of FIG. 5, except that it varies the comparison voltage range in response to the luminance control signal CLUM rather than the first shutter control signal CSHT1. Thus, the A/D converters 220 of FIGS. 7 and 8 may be configured so that the variable comparison voltage generators 221 and 221-1 receive the luminance control signal CLUM instead of the first shutter control signal CSHT1. Thereby, the A/D converters 220 of FIGS. 7 and 8 can be implemented into the A/D converter 320 of FIG. 10, and thus they are not shown separately.

According to circumstances, one of the first shutter control signal CSHT1 and the luminance control signal CLUM may be selected to vary the comparison voltage range. In order to select one of the first shutter control signal CSHT1 and the luminance control signal CLUM to thereby vary the comparison voltage range, a selection switch (not shown) for receiving the first shutter control signal CSHT1 and the luminance control signal CLUM is additionally provided, and the image data processor 330 applies a selection signal (not shown) to the selection switch, so that the selection switch can select one of the first shutter control signal CSHT1 and the luminance control signal CLUM to apply it to the comparison voltage generator 321. Here, the selection switch may be installed on the A/D converter 320. However, without the separate selection switch, the image data processor 330 may select one of the first shutter control signal CSHT1 and the luminance control signal CLUM to directly apply it to the comparison voltage generator 321.

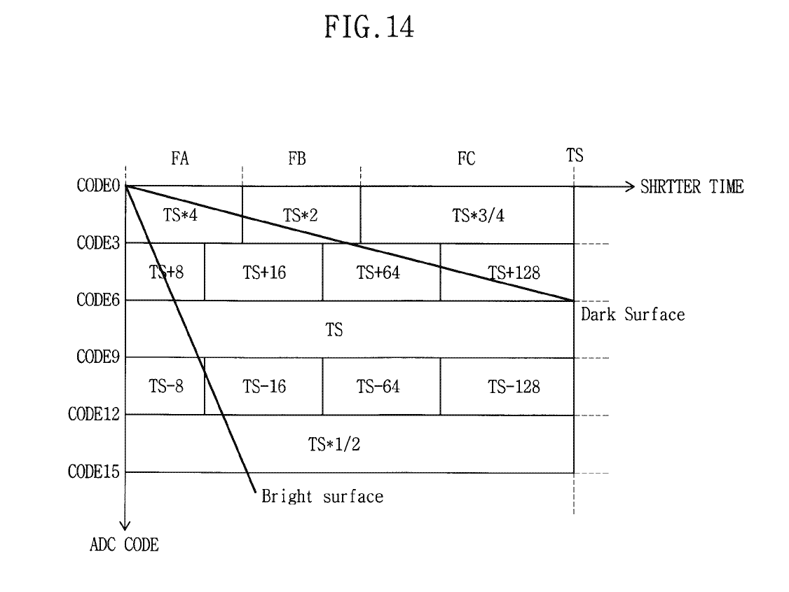

FIG. 11 is a block diagram showing an optical pointing device according to a third embodiment of the present invention.

As described above, the optical pointing device of FIG. 4 adjusts the exposure time, i.e. the shutter-on time in order to adjust the quantity of light incident on the image sensor 210. Further, the A/D converter 220 varies the comparison voltage range in response to the first shutter control signal CSHT1, and converts the analog signals IMO into the digital signals according to the varied comparison voltage range. This adjustment of the exposure time and the comparison voltage range is directed to obtain the high-resolution image and calculate the accurate movement value MV using the obtained image.

A conventional optical pointing device can adjust only the exposure time TS of an image sensor in order to obtain a high-resolution image. In contrast, the optical pointing device of FIG. 4 can vary the comparison voltage range. However, since the A/D converter 220 varies the comparison voltage range in response to the first shutter control signal CSHT1 that determines the exposure time TS, the optical pointing device of FIG. 4 cannot separately adjust the exposure time TS of the image sensor and the comparison voltage range in a practical sense.

If the exposure time TS of the image sensor and the comparison voltage range can be separately adjusted, it is possible to obtain a high-resolution image as well as an area capable of obtaining such an image. Since the exposure time TS of the image sensor 410 can generally be adjusted only within a designated range, minimum and maximum exposure times are preset. Thus, when a large quantity of light is incident on the image sensor 410 despite the exposure time TS of the image sensor 410 being minimum, or when a small quantity of light is incident on the image sensor 410 despite the exposure time TS of the image sensor 410 being maximum, it is difficult to obtain an accurate image. Further, when a current quantity of light incident on the image sensor 410 becomes much or less than a previous quantity of light within a narrow range, it is not necessary to adjust both the exposure time TS and the comparison voltage range.

In the optical pointing device of FIG. 11, an image data processor 430 applies a first shutter control signal CSHT1 to a shutter control circuit 440, and a separate conversion control signal CTR to an A/D converter 420. The first shutter control signal CSHT1 and the conversion control signal CTR are different from each other, but they are both generated by the image data processor 430 in response to a digital signals ADCO. Thus, the image data processor 430 may adjust one of the first shutter control signal CSHT1 and the conversion control signal CTR to which priority is given, and then adjust the other. The light source 400, image sensor 410 and shutter control circuit 440 are identical to the light source 200, image sensor 210 and shutter control circuit 240 of the optical pointing device of FIG. 4, and so description thereof will be omitted. Further, the A/D converter 420 is identical to the A/D converter 220 of FIG. 4, except that it receives the conversion control signal CTR instead of the first shutter control signal CSHT1, and so description thereof will not be made separately.

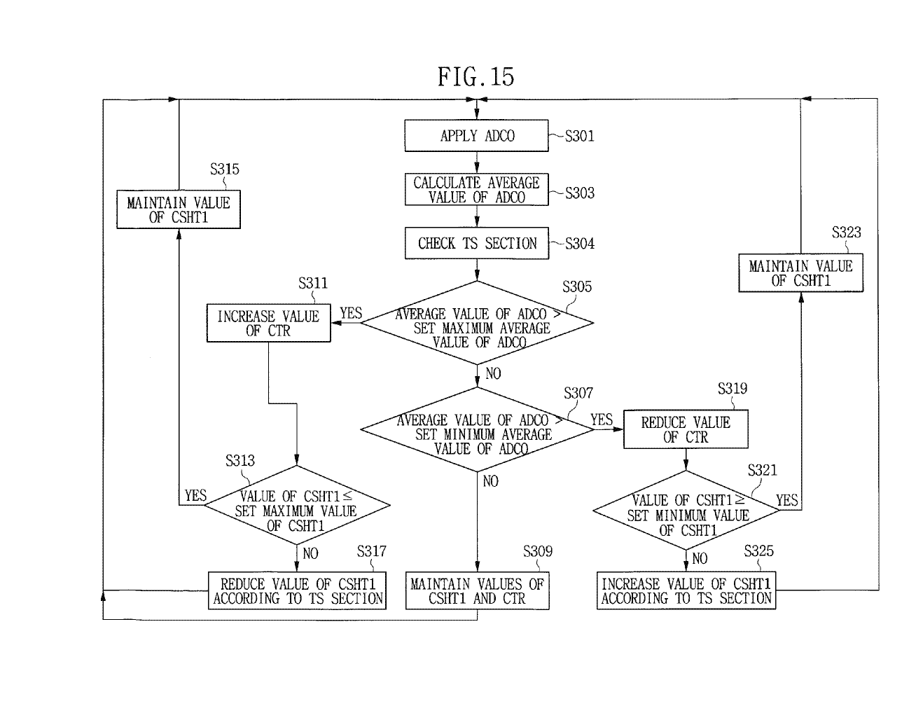

FIGS. 12 and 13 are flowcharts explaining how the image data processor of FIG. 11 adjusts the exposure time of the image sensor and the comparison voltage range.

FIG. 12 shows a method in which the image data processor gives priority to the comparison voltage range and adjusts the exposure time of the image sensor and the comparison voltage range.

First, in the event of initial operation of the optical pointing device, the image data processor 430 applies a conversion control signal CTR having a preset initial value to the A/D converter 420, and the first shutter control signal CSHT1 to the shutter control circuit 440. The shutter control circuit 440 controls an electronic shutter of the image sensor 410 in response to the first shutter control signal CSHT1 to determine the exposure time TS of the image sensor. The image sensor 410 outputs analog signals IMO of pixels thereof to the A/D converter 420 according to a quantity of light that is emitted from the light source 400 and reflected from a subject. The A/D converter 420 converts the analog signals IMO into digital signals ADCO in response to the conversion control signal CTR, and outputs the digital signals to the image data processor 430 (S101).

When receiving the digital signals ADCO of the pixels of the image sensor, the image data processor 430 calculates an average value of the received digital signals ADCO of the pixels (S103). It is determined whether or not the calculated average value is greater to a set maximum value (S105). If the calculated average value is less than or equal the maximum value, it is determined whether the average value is less than a set minimum value (S107). If the average value is greater than or equal the set minimum value, the average value results in a value between the set maximum and minimum values. Thus, the first shutter control signal CSHT1 for adjusting the exposure time and the conversion control signal CTR for varying the comparison voltage range are maintained without change (S109).

Here, the set maximum and minimum values are target maximum and minimum values of the average value for keeping the quantity of light incident on the image sensor maintained within a proper range.

When the average value is greater than the set maximum value, it means that a large quantity of light is incident on the image sensor 410. Thus, the conversion control signal CTR for adjusting the comparison voltage range is adjusted to increase its value so as to correspond to the analog signals IMO having a relatively high voltage level due to high luminance (S11). Then, it is determined whether or not a current value of the first shutter control signal CSHT1 is less than or equal to a set maximum value of the first shutter control signal CSHT1 (S113). If a current value of the first shutter control signal CSHT1 is less than or equal to a set maximum value of the first shutter control signal CSHT1, the first shutter control signal CSHT1 is maintained as it is (S115). However, if a current value of the first shutter control signal CSHT1 is greater than a set maximum value of the first shutter control signal CSHT1, the value of the first shutter control signal CSHT1 is reduced such that the exposure time TS is reduced (S117).

Here, it is assumed that the value of the first shutter control signal CSHT1 is proportional to the exposure time TS. Further, it is assumed that the A/D converter 420 adjusts the comparison voltage range so as to correspond to the analog signals IMO having a high voltage level when the conversion control signal CTR has a high value, and so as to correspond to the analog signals IMO having a low voltage level when the conversion control signal CTR has a low value.

Thus, in order to reduce the exposure time TS, it is necessary to reduce the value of the first shutter control signal CSHT1, and to increase the value of the conversion control signal CTR such that the comparison voltage range corresponds to the analog signals IMO having the high voltage level.

In contrast, when the average value is less than the set minimum value, it means that a small quantity of light is incident on the image sensor 410. Thus, the conversion control signal CTR for adjusting the comparison voltage range is adjusted to reduce its value so as to correspond to the analog signals IMO having a relatively low voltage level due to low luminance (S119). Then, it is determined whether or not a current value of the first shutter control signal CSHT1 is greater than or equal to a set minimum value of the first shutter control signal CSHT1 (S121). If a current value of the first shutter control signal CSHT1 is greater than or equal to a set minimum value of the first shutter control signal CSHT1, the first shutter control signal CSHT1 is maintained as it is (S123). However, if a current value of the first shutter control signal CSHT1 is less than a set minimum value of the first shutter control signal CSHT1, the value of the first shutter control signal CSHT1 is increased such that the exposure time TS is increased (S125).

FIG. 13 shows a method in which the image data processor gives priority to the exposure time of the image sensor and adjusts the exposure time and the comparison voltage range.

When the digital signals ADCO of the pixels of the image sensor are applied to the image data processor 430 by initial operation of the optical pointing device, the image data processor 430 calculates an average value of the applied digital signals ADCO of the pixels (S203). It is determined whether or not the calculated average value is greater than to a set maximum value (S205). If the calculated average value is less than or equal the maximum value, it is determined whether the average value is less than a set minimum value (S207). If the average value is greater than or equal the set minimum value, the average value results in a value between the set maximum and minimum values. Thus, the first shutter control signal CSHT1 for adjusting the exposure time and the conversion control signal CTR for varying the comparison voltage range are maintained without change (S209). In other words, the image data processor has the same operation as that of FIG. 12.

When the average value is greater than the set maximum value, the first shutter control signal CSHT1 is adjusted to reduce its value such that the exposure time TS is reduced (S211). Then, it is determined whether or not the value of the conversion control signal CTR for adjusting the comparison voltage range is less than or equal to a set maximum value of the conversion control signal CTR (S213). If the value of the conversion control signal CTR is less than or equal to a set maximum value of the conversion control signal CTR, the conversion control signal CTR is maintained as it is (S215). However, if the value of the conversion control signal CTR is greater than the set maximum value of the conversion control signal CTR, the value of the conversion control signal CTR is reduced (S217).

In contrast, when the average value is less than the set minimum value, it means that a small quantity of light is incident on the image sensor 410. Thus, the first shutter control signal CSHT1 is adjusted to increase its value such that the exposure time TS is increased (S219). Then, it is determined whether or not the value of the conversion control signal CTR for adjusting the comparison voltage range is less than or equal to a set minimum value of the conversion control signal CTR (S221). If the value of the conversion control signal CTR is greater than or equal to a set minimum value of the conversion control signal CTR, the conversion control signal CTR is maintained as it is (S223). However, if the value of the conversion control signal CTR is less than the set minimum value of the conversion control signal CTR, the value of the conversion control signal CTR is increased (S225).

Consequently, in FIGS. 12 and 13, the image data processor 430 adjusts the exposure time of the image sensor and the comparison voltage range by giving priority to one of the exposure time and the comparison voltage range. In practical use, the methods of FIGS. 12 and 13 are sequentially alternated. Thus, the determining steps such as step S113 of FIG. 12 and steps S213 and S221 of FIG. 13 are required.

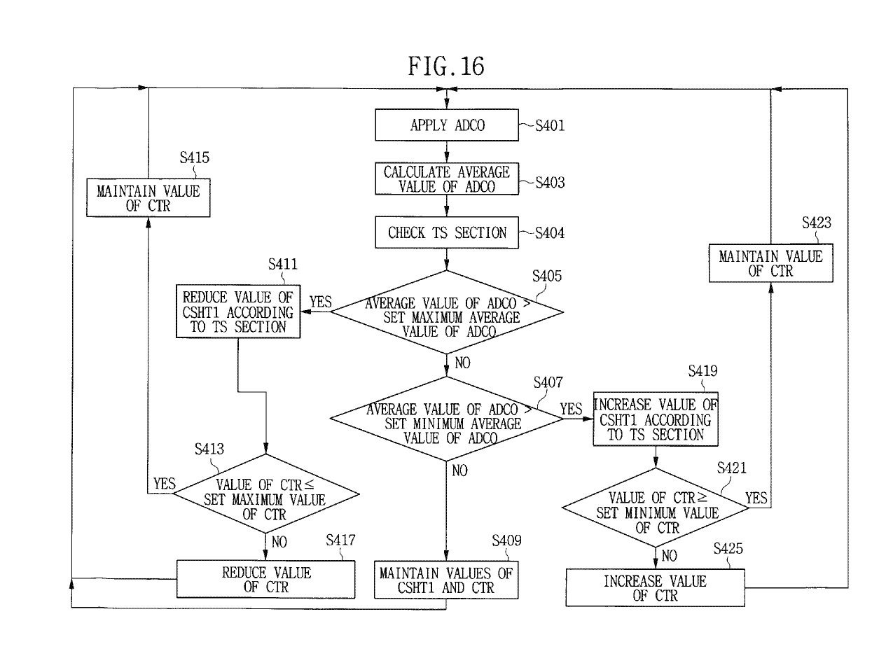

FIG. 14 is a view explaining a method of rapidly determining the exposure time of an image sensor in an optical pointing device according to an exemplary embodiment of the present invention.

In the optical pointing device as described above, the light incident on the image sensor is light that is reflected by a subject and input. Thus, the quantity of light incident on the image sensor varies according to whether the subject has a bright surface or a dark surface, and the exposure time TS is adjusted according to the quantity of incident light. Consequently, the exposure time TS is varied according to whether the subject has a bright surface or a dark surface. However, the surface of the subject may not have constant brightness. For example, when the surface of the subject has a pattern in which white and black colors are alternately arranged, the exposure time has to be sharply varied as the optical pointing device moves. This sharp variation is increased as the movement of the optical pointing device becomes faster. Further, even when the movement of the optical pointing device is slow, such variation is increased when the surface of the subject has a pattern in which the white and black colors are alternately arranged at very dense intervals. In this manner, when the optical pointing device quickly moves on the surface of the subject having the alternating bright and dark patterns, it is necessary to rapidly adjust the exposure time.

In order to rapidly determine the exposure time, the optical pointing device may include a separate image sensor as shown in FIG. 9. As a concrete example for the separate image sensor, a part of the image sensor can be used as the image sensor. The easiest method is to use circumferential pixels of the image sensor, which are irrelevant to the image used in the optical pointing device, as pixels for the image sensor. The optical pointing device of FIG. 9 requiring the separate image sensor makes its design difficult, and requires additional production cost.

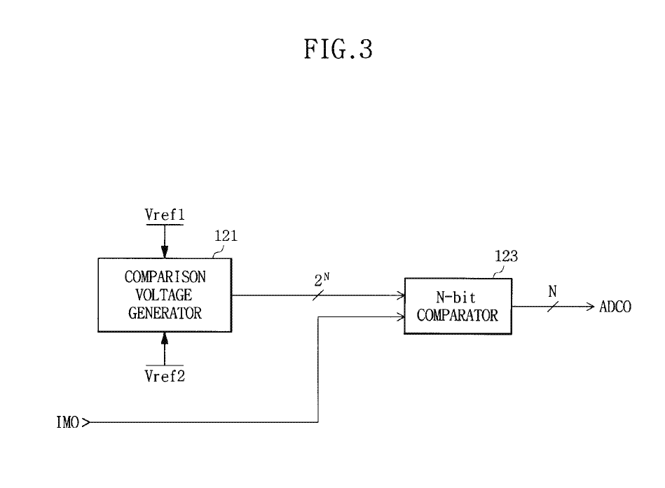

For this reason, FIG. 14 shows an example in which the exposure time TS is set as a unit of section according to a code range so as to rapidly determine the exposure time without such a separate image sensor. Here, as in FIG. 2, it is assumed that the code range is defined as a value between 0 bits and 15 bits and that a central code value is 7 bits.

The method of rapidly determining the exposure time in the optical pointing device will be described with reference to FIG. 14. First, when a current average value of digital signals ADCO output by the A/D converter ranges from 0 to 3, and when a previous exposure TS belongs to section A FA, a current exposure time TS is set to four times the previous exposure time. Of course, when this set value exceeds a maximum exposure time TSmax, the current exposure time is set to the maximum exposure time TSmax. Further, the exposure time TS is actually set to a minimum value aside from 0 (zero). When the average value of digital signals ADCO ranges from 0 to 3, and when the previous exposure TS belongs to section C FC, the current exposure time TS is set to three fourths the previous exposure time.

If the average value of digital signals ADCO ranges from 6 to 9, the previous exposure time TS is maintained as it is. In other words, since the average value of digital signals ADCO is already located at the center of the code range, it is not necessary to adjust the exposure time. Meanwhile, when the average value of digital signals ADCO ranges from 12 to 15, the current exposure time is set to half the previous exposure time.

In FIG. 14, it is shown that the exposure time can be set to at least three sections FA, FB and FC for the code range from 3 to 6 and the code range from 9 to 12. Further, the sections for the exposure time may be differently set for each code range. In FIG. 14, a numeral added to the exposure time TS is relevant to a system clock value. When a system clock is varied or an operating clock of the shutter control circuit is controlled in order to reduce consumption power and increase an operating speed in the optical pointing device, it is natural that the numeral added to the exposure time TS and the sections of FIG. 14 can be varied.

Consequently, the exposure time of FIG. 14 is adjusted by dividing the average value of the digital signals ADCO and the exposure time TS into multiple sections, discriminating the current exposure time, the range corresponding to the average value of the digital signals ADCO determined according to the current exposure time, and determining the next exposure time. Since the current exposure time is designated according to a section, the exposure time may not be varied when the surface of the subject is uniform. Even if the exposure time is varied, the exposure time is set according to the section, so that the exposure time can be rapidly set.

Here, if the average value of the digital signals ADCO and the exposure time TS continue to be varied in the proximity of a boundary of each section, the exposure time TS has to be continuously varied, which makes it difficult to rapidly set the exposure time. Thus, the sections of the average value of the digital signals ADCO and the exposure time TS are set with a predetermined level of margin (e.g. a code range between 0.0 and 0.3) at a boundary zone of each section, so that the number of times of the variation of the exposure time TS can be reduced. This is based on a method of adding a kind of hysteresis characteristic on determining the exposure time. This method of adding the hysteresis characteristic is well known in various fields, and so detailed description thereof will be omitted.

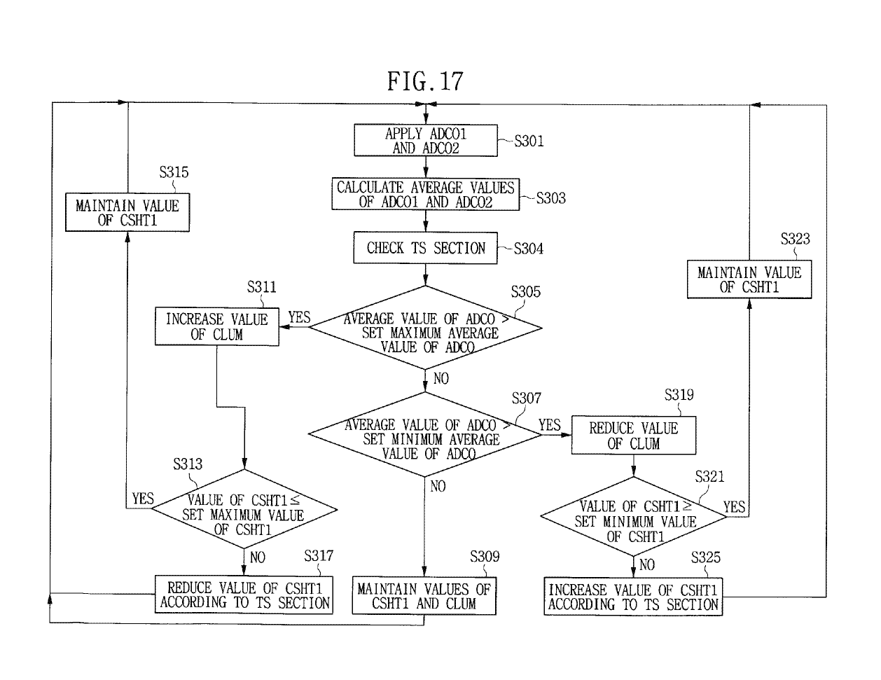

FIGS. 15 and 16 are flowcharts explaining how an optical pointing device adjusts the exposure time of an image sensor and a comparison voltage range using the method of FIG. 14.

FIG. 15 shows a method in which the image data processor gives priority to the comparison voltage range and adjusts the exposure time of the image sensor and the comparison voltage range.

As in FIG. 12, when the digital signals ADCO of the pixels of the image sensor are applied to the image data processor 430 by initial operation of the optical pointing device, the image data processor 430 calculates an average value of the applied digital signals of the pixels (S303). Then, a code range corresponding to the calculated average value of the digital signals ADCO is checked (S304). It is determined whether or not the calculated average value is greater than to a set maximum value (S305). If the calculated average value is less than or equal the set maximum value, it is determined whether the calculated average value is less than a set minimum value (S307). When the average value is greater than or equal the set minimum value, the average value results in a value between the set maximum and minimum values. Thus, the first shutter control signal CSHT1 for adjusting the exposure time and the conversion control signal CTR for varying the comparison voltage range are maintained without change (S309).

When the average value is greater than the set maximum value, the conversion control signal CTR for adjusting the comparison voltage range is adjusted to increase its value so as to correspond to the analog signals IMO having a relatively high voltage level due to high luminance (S311). Then, it is determined whether or not a current value of the first shutter control signal CSHT1 is less than or equal to a set maximum value of the first shutter control signal CSHT1 (S313). If a current value of the first shutter control signal CSHT1 is less than or equal to a set maximum value of the first shutter control signal CSHT1, the first shutter control signal CSHT1 is maintained as it is (S315). However, if a current value of the first shutter control signal CSHT1 is greater than a set maximum value of the first shutter control signal CSHT1, the value of the first shutter control signal CSHT1 is reduced so as to correspond to a smaller section of the exposure time TS (S317).

As described with reference to FIG. 12, it is assumed that the value of the first shutter control signal CSHT1 is proportional to the exposure time TS. However, since the exposure time TS is divided according to section in FIG. 15, the value of the first shutter control signal CSHT1 is discretely varied in response to the exposure time TS divided according to section. Further, it is assumed that the A/D converter 420 adjusts the comparison voltage range so as to correspond to the analog signals IMO having a high voltage level when the conversion control signal CTR has a high value, and so as to correspond to the analog signals IMO having a low voltage level when the conversion control signal CTR has a low value.

In contrast, when the average value is less than the set minimum value, it means that a small quantity of light is incident on the image sensor 410. Thus, the conversion control signal CTR for adjusting the comparison voltage range is adjusted to reduce its value so as to correspond to the analog signals IMO having a relatively low voltage level due to low luminance (S319). Then, it is determined whether or not a current value of the first shutter control signal CSHT1 is greater than or equal to a set minimum value of the first shutter control signal CSHT1 (S321). If a current value of the first shutter control signal CSHT1 is greater than or equal to a set minimum value of the first shutter control signal CSHT1, the first shutter control signal CSHT1 is maintained as it is (S323). However, if a current value of the first shutter control signal CSHT1 is less than a set minimum value of the first shutter control signal CSHT1, the value of the first shutter control signal CSHT1 is increased so as to correspond to greater section of the exposure time TS (S325).

FIG. 16 shows a method in which the image data processor gives priority to the exposure time of the image sensor and adjusts the exposure time and the comparison voltage range.

When the digital signals ADCO of the pixels of the image sensor are applied to the image data processor 430 by initial operation of the optical pointing device, the image data processor 430 calculates an average value of the applied digital signals ADCO of the pixels (S403). Then, a code range corresponding to the calculated average value of the digital signals ADCO is checked (S404). It is determined whether or not the calculated average value is greater than to a set maximum value (S405). If the calculated average value is less than or equal the maximum value, it is determined whether the average value is less than a set minimum value (S407). If the average value is greater than or equal the set minimum value, the average value results in a value between the set maximum and minimum values. Thus, the first shutter control signal CSHT1 for adjusting the exposure time and the conversion control signal CTR for varying the comparison voltage range are maintained without change (S409).

When the average value is greater than the set maximum value, the first shutter control signal CSHT1 is adjusted to reduce its value so as to correspond to a smaller section of the exposure time TS (S411). Then, it is determined whether or not the value of the conversion control signal CTR for adjusting the comparison voltage range is less than or equal to a set maximum value (S413) of the conversion control signal CTR. If the value of the conversion control signal CTR is less than or equal to a set maximum value of the conversion control signal CTR, the conversion control signal CTR is maintained as it is (S415). However, if the value of the conversion control signal CTR is greater than the set maximum value of the conversion control signal CTR, the value of the conversion control signal CTR is reduced (S417).

In contrast, when the average value is less than the set minimum value, the conversion control signal CTR for adjusting the comparison voltage range is adjusted to increase its value so as to correspond to a greater section of the exposure time TS (S419). Then, it is determined whether or not the value of the conversion control signal CTR for adjusting the comparison voltage range is greater than or equal to a set minimum value of the conversion control signal CTR (S421). If the value of the conversion control signal CTR is greater than or equal to a set minimum value of the conversion control signal CTR, the conversion control signal CTR is maintained as it is (S423). However, if the value of the conversion control signal CTR is less than the set minimum value of the conversion control signal CTR, the value of the conversion control signal CTR is increased (S425).

In practical use, it is natural that the methods of FIGS. 15 and 16 are sequentially alternated. In this case, the conversion control signal CTR or the first shutter control signal CSHT1 may be beyond the set maximum or minimum value, so that the determining steps such as step S313 of FIG. 15 and steps S413 and S421 of FIG. 16 are required.

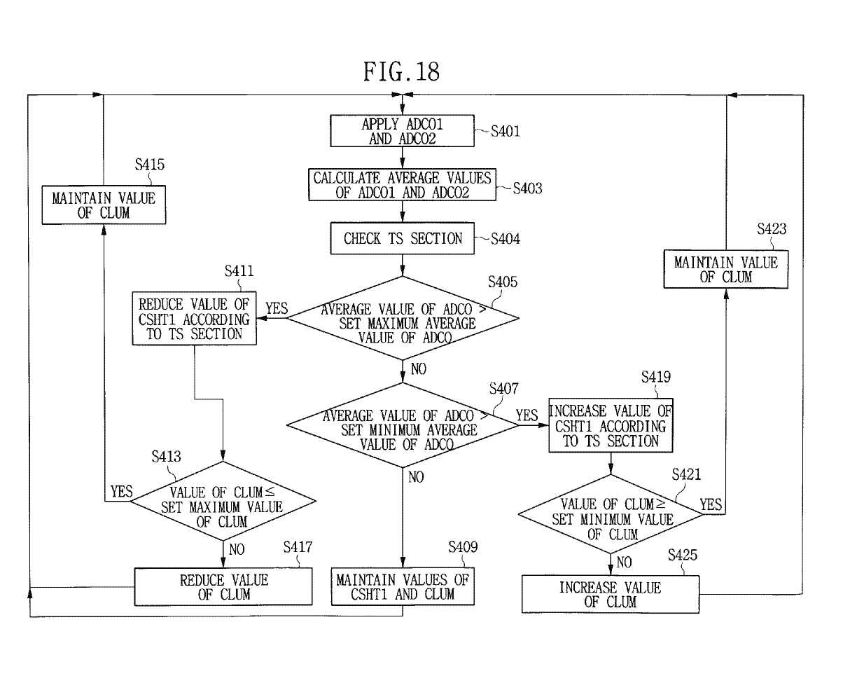

FIGS. 17 and 18 are flowcharts explaining how the optical pointing device of FIG. 9 adjusts the exposure time of the image sensor and the comparison voltage range using the method of FIG. 13.

The optical pointing device of FIG. 9 includes the second image sensor 350 and the second A/D converter 360 generating the second digital signals ADCO2 in response to the second analog signals IMO2 output by the second image sensor 350, in addition to the first image sensor 310 and the first A/D converter 320. The image data processor 330 outputs the luminance control signal CLUM to the first A/D converter 320 in response to the second digital signals ADCO2, as well as the first shutter control signal CSHT1 to the shutter control signal 340 in response to the first digital signals ADCO1. The methods of FIGS. 17 and 18 are similar to those of FIGS. 15 and 16, except that the luminance control signal CLUM generated in response to the second digital signals ADCO2 is used instead of the conversion control signal CTR. The luminance control signal CLUM and the conversion control signal CTR have been described as different signals. However, since both of the two signals are for varying the comparison voltage range of the A/D converter, the luminance control signal CLUM may be interpreted as the conversion control signal CTR.

Further, as described above, the first shutter control signal CSHT1 may be generated in response to the second digital signals ADCO2. Thus, the first shutter control signal CSHT1 may be generated in response to one of the first digital signals ADCO1 and the second digital signals ADCO2. At this time, the first shutter control signal CSHT1 may be generated so as to correspond to the exposure time section. If the first shutter control signal CSHT1 is generated in response to the second digital signals ADCO2 so as to correspond to the exposure time section, the first shutter control signal CSHT1 can be generated as rapidly as possible. Further, as described above, the image data processor 330 may directly generate the second shutter control signal CSHT2 in response to the first and second digital signals ADCO1 and ADCO2.

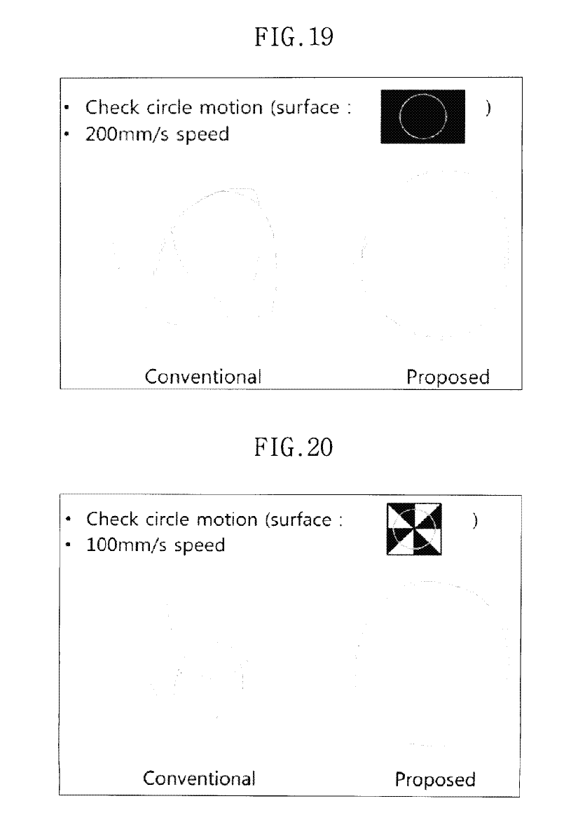

FIGS. 19 and 20 show an operating difference between a conventional optical pointing device and a proposed optical pointing device.

As shown in FIGS. 19 and 20, the proposed optical pointing device can not only determine the exposure time at a higher speed when using the methods of FIGS. 15 through 18, but can also obtain the high-resolution image and the resulting accurate movement value even when using a low-resolution A/D converter. Thus, even when the surface of the subject is mixed with the bright and dark patterns, and even when the optical pointing device rapidly moves, the accurate movement value can be calculated.

The case of varying the comparison voltage range of the N-bit comparator has been described above. However, the DC offset of an input signal may be varied. In this case, similar effects can be obtained.

As set forth above, the optical pointing device and the method of adjusting exposure time and comparison voltage range of the optical pointing device can obtain a high-resolution image using a low-resolution A/D converter, so that they can calculate an accurate movement value, and reduce production cost and power consumption.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An optical pointing device comprising:
a light source emitting light;
a first image sensor on which the light reflected from a subject is incident, receiving an image of the subject in a form of the light to generate first analog signals of pixels;
a first analog-to-digital (A/D) converter varying a comparison voltage range according to a conversion control signal, and converting the first analog signals of the pixels into first digital signals of the pixels according to the varied comparison voltage range; and
an image data processor calculating a movement value in response to the first digital signals of the pixels, and generating and outputting a first shutter control signal for controlling an exposure time of the first image sensor.

2. The optical pointing device as claimed in claim 1, wherein the first A/D converter includes:
a control signal generator generating a value of voltage corresponding to the conversion control signal;
a variable comparison voltage generator varying the comparison voltage range according to the voltage value, and generating and outputting multiple comparison voltages corresponding to the varied comparison voltage range; and
a comparator converting the analog signals of the pixels into the digital signals of the pixels using the multiple comparison voltages of the variable comparison voltage generator.

3. The optical pointing device as claimed in claim 2, wherein the variable comparison voltage generator includes:
a comparison voltage range adjuster continuously varying the comparison voltage range according to the voltage value corresponding to the conversion control signal; and
a comparison voltage generator generating and outputting the multiple comparison voltages corresponding to the varied comparison voltage range.

4. The optical pointing device as claimed in claim 3, wherein the comparison voltage range adjuster includes a variable resistor.

5. The optical pointing device as claimed in claim 2, wherein the variable comparison voltage generator includes:
a comparison voltage range adjuster setting multiple comparison voltage ranges, and selecting at least one of the comparison voltage ranges according to the conversion control signal; and
a comparison voltage generator generating and outputting the multiple comparison voltages corresponding to the selected comparison voltage range.

6. The optical pointing device as claimed in claim 5, wherein the comparison voltage range adjuster includes:
a predetermined number of switches, each of which is connected to a supply voltage on one side thereof and is controlled in response to the conversion control signal; and
a predetermined number of resistors connected between the other sides of the switches, respectively, and the comparison voltage generator.

7. The optical pointing device as claimed in claim 1, further comprising a shutter control circuit generating a second shutter control signal having a corresponding pulse width in response to the first shutter control signal.

8. The optical pointing device as claimed in claim 7, wherein the image data processor includes the shutter control circuit.

9. The optical pointing device as claimed in claim 7, wherein the conversion control signal and the first shutter control signal each have a predetermined code value.

10. The optical pointing device as claimed in claim 7, wherein the image data processor directly generates the second shutter control signal in response to the first digital signals.

11. The optical pointing device as claimed in claim 1, wherein the image data processor calculates an average value of the first digital signals of the pixels, and maintains values of the conversion control signal and the first shutter control signal when the calculated average value of the first digital signals is between a set maximum average value of the first digital signals and a set minimum average value of the first digital signals.

12. The optical pointing device as claimed in claim 11, wherein the image data processor adjusts a value of the conversion control signal when the calculated average value of the first digital signals is greater than the maximum average value of the first digital signals or is less than the minimum average value of the first digital signals, and then adjusts a value of the first shutter control signal when the value of the first shutter control signal is greater than a set maximum value of the first shutter control signal or is less than a set minimum value of the first shutter control signal.

13. The optical pointing device as claimed in claim 11, wherein the image data processor adjusts a value of the first shutter control signal when the calculated average value of the first digital signals is greater than the maximum average value of the first digital signals or is less than the minimum average value of the first digital signals, and then adjusts a value of the conversion control signal when the value of the conversion control signal is greater than a set maximum value of the conversion control signal or is less than a set minimum value of the conversion control signal.

14. The optical pointing device as claimed in claim 1, wherein the image data processor divides the exposure time of the first image sensor and a code value corresponding to an average value of the first digital signals into designated time and code sections respectively, obtains one of the sections corresponding to the exposure time determined during previous operation and the average value of the first digital signals calculated at present, and adjusts the first shutter control signal to have the code value corresponding to the obtained section.

15. The optical pointing device as claimed in claim 14, further comprising:
a second image sensor having relatively smaller pixels than those of the first image sensor, receiving the image of the subject in the form of the light to generate second analog signals of the pixels; and
a second A/D converter converting the second analog signals of the pixels into second digital signals of the pixels according to a fixed comparison voltage range.

16. The optical pointing device as claimed in claim 15, wherein the image data processor generates the conversion control signal in response to the second digital signals of the pixels.

17. The optical pointing device as claimed in claim 16, wherein the image data processor generates the first shutter control signal in response to the second digital signals of the pixels.

18. The optical pointing device as claimed in claim 15, wherein the image data processor divides an exposure time of the second image sensor and a code value corresponding to an average value of the second digital signals into designated time and code sections respectively, obtains one of the sections corresponding to the exposure time determined during previous operation and the average value of the digital signals calculated at present, and adjusts the first shutter control signal to have the code value corresponding to the obtained section.

19. The optical pointing device as claimed in claim 1, wherein the image data processor calculates the movement value using correlation between the first digital signals of the pixels stored during previous operation and the first digital signals of the pixels applied at present.

20. A method of adjusting an exposure time and a comparison voltage range of an optical pointing device, the method comprising:
emitting light;
receiving the light reflected from a subject, and receiving an image of the subject in a form of the light to generate first analog signals of pixels;
varying a comparison voltage range according to a conversion control signal, and converting the first analog signals of the pixels into first digital signals of the pixels according to the varied comparison voltage range;
calculating a movement value using correlation between the first digital signals of the pixels stored during previous operation and the first digital signals of the pixels applied at present; and
adjusting and outputting the conversion control signal and a first shutter control signal for controlling an exposure time of the first image sensor.

21. The method as claimed in claim 20, wherein the adjusting of the conversion control signal and the first shutter control signal includes:
calculating an average value of the first digital signals of the pixels, and determining whether or not the calculated average value of the first digital signals exists between a set maximum average value of the first digital signals and a set minimum average value of the first digital signals;
maintaining values of the conversion control signal and the first shutter control signal when the calculated average value of the first digital signals exists between the set maximum average value of the first digital signals and the set minimum average value of the first digital signals; and
adjusting the values of the conversion control signal and the first shutter control signal when the calculated average value of the first digital signals is greater than the set maximum average value of the first digital signals or is less than the set minimum average value of the first digital signals.

22. The method as claimed in claim 21, wherein the adjusting the values of the conversion control signal and the first shutter control signal includes adjusting the value of the conversion control signal when the calculated average value of the first digital signals is greater than the maximum average value of the first digital signals or is less than the minimum average value of the first digital signals, and then adjusting the value of the first shutter control signal.

23. The method as claimed in claim 22, wherein the adjusting the values of the conversion control signal and the first shutter control signal includes:
increasing the value of the conversion control signal when the calculated average value of the first digital signals is greater than the set maximum average value of the first digital signals;
maintaining the value of the first shutter control signal when the value of the first shutter control signal is less than or equal to a set maximum value of the first shutter control signal; and
reducing the value of the first shutter control signal when the value of the first shutter control signal is greater than the set maximum value of the first shutter control signal.

24. The method as claimed in claim 22, wherein the adjusting the values of the conversion control signal and the first shutter control signal includes:
reducing the value of the conversion control signal when the calculated average value of the first digital signals is greater than the set maximum average value of the first digital signals;
maintaining the value of the first shutter control signal when the value of the first shutter control signal is greater than or equal to a set minimum value of the first shutter control signal; and
increasing the value of the first shutter control signal when the value of the first shutter control signal is less than the set minimum value of the first shutter control signal.

25. The method as claimed in claim 21, wherein the adjusting the values of the conversion control signal and the first shutter control signal includes adjusting the value of the first shutter control signal when the calculated average value of the first digital signals is greater than the maximum average value of the first digital signals or is less than the minimum average value of the first digital signals, and then the value of adjusts the conversion control signal.

26. The method as claimed in claim 25, wherein the adjusting the values of the conversion control signal and the first shutter control signal includes:
reducing the value of the first shutter control signal when the calculated average value of the first digital signals is greater than the set maximum average value of the first digital signals;
maintaining the value of the conversion control signal when the value of the conversion control signal is less than or equal to a set maximum value of the conversion control signal; and
increasing the value of the conversion control signal when the value of the first shutter control signal is greater than the set maximum value of the conversion control signal.

27. The method as claimed in claim 25, wherein the adjusting of the values the conversion control signal and the first shutter control signal includes:
increasing the value of the first shutter control signal when the calculated average value of the first digital signals is less than the set maximum average value of the first digital signals;
maintaining the value of the conversion control signal when the value of the conversion control signal is greater than or equal to a set minimum value of the conversion control signal; and
reducing the value of the conversion control signal when the value of the first shutter control signal is less than the set minimum value of the conversion control signal; and

28. The method as claimed in claim 21, further comprising dividing the exposure time of the first image sensor and a code value corresponding to an average value of the first digital signals into designated time and code sections respectively, and obtaining one of the sections corresponding to the exposure time determined during previous operation and the average value of the first digital signals calculated at present.

29. The method as claimed in claim 28, wherein the adjusting the values of the conversion control signal and the first shutter control signal includes adjusting the value of the conversion control signal when the calculated average value of the first digital signals is greater than the maximum average value of the first digital signals or is less than the minimum average value of the first digital signals, and then adjusting the value of the first shutter control signal to have the code value corresponding to the obtained section.

30. The method as claimed in claim 28, wherein the adjusting the values of the conversion control signal and the first shutter control signal includes adjusting the value of the first shutter control signal to have the code value corresponding to the obtained section when the calculated average value of the first digital signals is greater than the maximum average value of the first digital signals or is less than the minimum average value of the first digital signals, and then adjusting the value of the conversion control signal.

31. The method as claimed in claim 21, wherein the optical point system further includes a second image sensor having relatively smaller pixels than those of the first image sensor, receiving the image of the subject in the form of the light to generate second analog signals of the pixels, and a second A/D converter converting the second analog signals of the pixels into second digital signals of the pixels according to a fixed comparison voltage range, and further comprising:
calculating an average value of the second digital signals of the pixels; and
determining whether or not the calculated average value of the second digital signals exists between a set maximum average value of the second digital signals and a set minimum average value of the second digital signals.

32. The method as claimed in claim 31, further comprising dividing an exposure time of the second image sensor and a code value corresponding to the average value of the digital signals into designated time and code sections respectively, and obtaining one of the sections corresponding to the exposure time of the second image sensor determined during previous operation and the average value of the digital signals calculated at present.
